(19) United States
(12) Patent Application Publication
(10) Pub. No.: US 2007/0183105 A1
(43) Pub. Date: Aug. 9, 2007

(54) ELECTROSTATIC DISCHARGE PROTECTION CIRCUIT

(75) Inventor: Atsushi NAGAYAMA, Tokyo (JP)

Correspondence Address: NIXON PEABODY, LLP, 401 9TH STREET, NW, SUITE 900, WASHINGTON, DC, 20004-2128, US

(73) Assignee: Oki Electric Industry Co., Ltd., Tokyo (JP)

(21) Appl. No.: 11/670,110

(22) Filed: Feb. 1, 2007

(30) Foreign Application Priority Data
Feb. 8, 2006 (JP) 2006-030495

(51) Int. Cl. H02H 9/00

(52) U.S. Cl. 361/56

(57) ABSTRACT

An NMOS diode-connected in a backward direction between a power supply terminal and a ground terminal is provided as a protective element. Further, a band-pass blocking filter for blocking the passage of a frequency component of an ESD current is provided between the power supply terminal and an internal circuit. Thus, the inflow of an ESD current having a high frequency component into the internal circuit is blocked by the filter. When a potential VDD at the power supply terminal rises, the NMOS used as the protective element breaks down precedently. Thus, the voltage at the power supply terminal is reduced and hence the internal circuit is protected from the ESD current.

### BACKGROUND OF THE INVENTION

The present invention relates to an electrostatic discharge (hereinafter called “ESD”) protection circuit provided within a semiconductor integrated circuit (hereinafter called “LSI”).

An ESD breakdown of an LSI has been considered to occur because a large ESD current flows into transistors or the like of an internal circuit by application of a high voltage based on static electricity charged on a human body or the like to an external terminal of the LSI, and transistors or the like are permanently destroyed due to heat caused by the ESD current. Therefore, a protective element such as a high-capacity transistor or diode or the like hard to break down even though a large current flows when a breakdown voltage is low and it breaks down is provided inside the external terminal of the LSI to protect the internal circuit from the ESD current.

FIG. 2 is a configuration diagram showing an outline of an LSI equipped with a conventional ESD protection circuit

The LSI includes a power supply terminal 1 supplied with a power supply voltage VDD, a ground terminal 2 connected to a ground potential GND, an input terminal 3 supplied with an input signal IN, an internal circuit 4 that performs a predetermined logic operation according to the input signal IN, and an output terminal 5 from which an output signal OUT corresponding to the result based on the logic operation of the internal circuit 4 is outputted.

Further, the present LSI is provided with, as an ESD protection circuit, a P channel MOS transistor (hereinafter called “PMOS”) 6 diode-connected between the power supply terminal 1 and the input terminal 3 and having a cathode connected to the power supply terminal 1 and an anode connected to the input terminal 3, and an N channel MOS transistor (hereinafter called “NMOS”) 7 diode-connected between the ground terminal 2 and the input terminal 3 and having an anode connected to the ground terminal 2 and a cathode connected to the input terminal 3. The output side of the internal circuit 4 is connected to the output terminal 5 via an inverter 8 constituted of a PMOS 8p and an NMOS 8n. The LSI also has an NMOS 9 diode-connected between the power supply terminal 1 and the ground terminal 2 and having a cathode connected to the power supply terminal 1 and an anode connected to the ground terminal 2.

When an ESD current flows into the input terminal 3 in a grounded state of the ground terminal 2 in the LSI, the PMOS 6 is brought to an ON state to allow the ESD current to flow into the power supply terminal 1 side. As to a surge current having flowed into the power supply terminal 1 side, only a very small current is allowed to flow as compared with the ESD current because the internal resistance of the internal circuit 4 is high, although there exists no path through it flows, except for the internal circuit 4. Thus, the potential at the input terminal 3 rises. Thereafter, when the voltage at the input terminal 3 reaches a breakdown voltage of the NMOS 7, a parasitic bipolar transistor of the NMOS 7 is brought into conduction to allow the ESD current to flow into the ground terminal 2 side. With this operation, the internal circuit 4 is protected from the ESD current having flowed into the input terminal 3.

When an ESD current flows into the output terminal 5 in a state in which the ground terminal 2 is being grounded, the PMOS 8p is brought to an ON state to allow the ESD current to flow into the power supply terminal 1 side. As to a surge current having flowed into the power supply terminal 1 side, only a very small current is allowed to flow as compared with the ESD current because the internal resistance of the internal circuit 4 is high, although there exists no path through it flows, except for the internal circuit 4. Thus, the potential at the output terminal 5 rises. Thereafter, when the voltage at the output terminal 5 reaches a breakdown voltage of the NMOS 8n, a parasitic bipolar transistor of the NMOS 8n is brought into conduction to allow the ESD current to flow into the ground terminal 2 side. With this operation, the internal circuit 4 is protected from the ESD current having flowed into the output terminal 5.

On the other hand, when an ESD current flows into the power supply terminal 1 in a state in which the ground terminal 2 is being grounded, there exists no path through which it flows, except for the internal circuit 4. Since, however, the internal circuit 4 is high in internal resistance, only a very small current is allowed to flow as compared with the ESD current. Therefore, the voltage at the power supply terminal 1 rises. When the voltage at the power supply terminal 1 reaches a breakdown voltage of the NMOS 9, a parasitic bipolar transistor of the NMOS 9 is brought into conduction. With this operation, the ESD current applied to the power supply terminal 1 flows into the ground terminal 2 through the NMOS 9, so that the internal circuit 4 is protected from the ESD current.

The above prior art has been disclosed in Japanese Unexamined Patent Publication No. 2001-83217.

However, the LSI involves the following problems.

In such an LSI small in circuit scale as to realize a timer function, for example, the parasitic capacitances included in its circuit are reduced as compared with a large scale LSI. In such an ESD protection circuit as shown in FIG. 2, the voltage applied to the corresponding transistor of the internal circuit 4 reaches the breakdown voltage simultaneously with the NMOS 9 corresponding to the protective element or prior to the NMOS 9 when an ESD current large in tilt and cycle as in a human body model (HBM) typified by ESD is inputted. Further, the time required to cause the ESD current to flow becomes long as compared with other model such as a charged device model (CDM). Since the transistor of the internal circuit 4 is not an element having the capability to allow the ESD current to flow as in the protective element, a problem arises in that it breaks down prior to the operation of the protective element.

### SUMMARY OF THE INVENTION

With the foregoing in view, it is therefore an object of the present invention to provide an ESD protection circuit capable of reliably protecting an internal circuit from an ESD current.

According to one aspect of the present invention, there is provided an electrostatic discharge protection circuit for protecting an internal circuit from an ESD current flowing into a power supply terminal of an LSI, comprising a protective element which is connected between the power supply terminal and a ground terminal and breaks down when a voltage of a constant value or larger is applied; and a filter which is provided between the power supply terminal and the internal circuit and blocks passage of a frequency component of the ESD current.

In the present invention, the filter for blocking the passage of the frequency component of the ESD current is provided between the power supply terminal and the internal circuit in the LSI. Therefore, the inflow of the ESD current into the internal circuit is blocked. Further, when the potential at the power supply terminal rises due to the ESD current, the protective element connected between the power supply terminal and the ground terminal breaks down precedently. Thus, an advantageous effect is brought about in that the potential at the power supply terminal is lowered and the internal circuit is protected from the ESD current.

### BRIEF DESCRIPTION OF THE DRAWINGS

While the specification concludes with claims particularly pointing out and distinctly claiming the subject matter which is regarded as the invention, it is believed that the invention, the objects and features of the invention and further objects, features and advantages thereof will be better understood from the following description taken in connection with the accompanying drawings in which:

FIG. is a configuration diagram showing an LSI equipped with an ESD protection circuit according to a first embodiment of the present invention;

FIG. 2 is a configuration diagram illustrating an outline of an LSI equipped with a conventional ESD protection circuit;

FIG. 3 is a signal waveform diagram showing the operation of FIG. 1; and

FIG. 4 is a configuration diagram depicting an LSI equipped with an ESD protection circuit according to a second embodiment of the present invention.

### DETAILED DESCRIPTION OF THE PREFERRED EMBODIMENTS

As a filter provided between a power supply terminal and an internal circuit in an LSI, a band-pass blocking filter or a low-pass filter constituted of resistive elements and capacitive elements is used.

The above and other objects and novel features of the present invention will become more completely apparent from the following descriptions of preferred embodiments when the same is read with reference to the accompanying drawings. The drawings, however, are for the purpose of illustration only and by no means limitative of the invention.

### First Preferred Embodiment

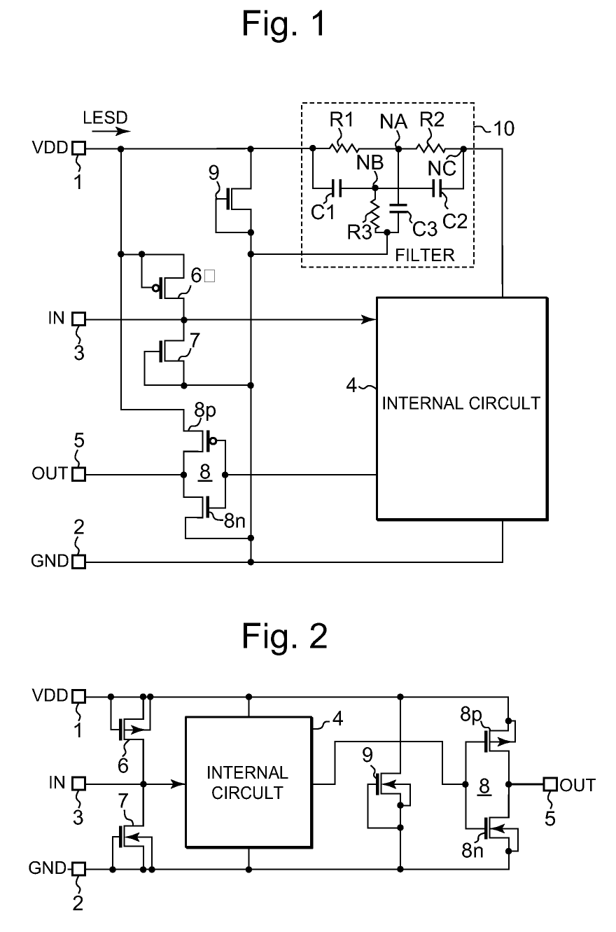

FIG. 1 is a configuration diagram of an LSI equipped with an ESD protection circuit according to a first embodiment of the present invention. Constituent elements common to those shown in FIG. 2 are given common reference numerals respectively.

The LSI includes a power supply terminal 1 to which a power supply voltage VDD is applied, a ground terminal 2 connected to a ground potential GND, an input terminal 3 supplied with an input signal IN, an internal circuit 4 that performs a predetermined logic operation according to the input signal IN, and an output terminal 5 from which an output signal OUT corresponding to the result based on the logic operation of the internal circuit 4 is outputted.

Further, the LSI includes, as the ESD protection circuit, an NMOS 9 diode-connected between the power supply terminal 1 and the ground terminal 2 and having a cathode connected to the power supply terminal 1 and an anode connected to the ground terminal 2, and a filter 10 for attenuating a specific frequency band for a voltage generated by an ESD current supplied to the power supply terminal 1. These NMOS 9 and filter 10 may preferably be disposed with as short a wire as possible adjacent to the power supply terminal 1 to prevent the flowing of the ESD current into the LSI.

The filter 10 is of a twin T-type notch filter (band-pass blocking filter) and comprises resistive elements R1 and R2 connected between the power supply terminal 1 and a node NC via a node NA interposed therebetween, capacitive elements C1 and C2 connected therebetween via a node NB interposed therebetween, a capacitive element C3 connected between the node NA and the ground terminal 2, and a resistive element R3 connected between the node NB and the ground terminal 2. The values of the resistive elements R1 through R3 and capacitive elements C1 through C3 are set to such values as to remove a frequency band of, for example, 2 MHz for the purpose of blocking an ESD current of a human body model. Incidentally, the node NC on the output side of the filter 10 serves as a power supply terminal of the internal circuit 4.

In order to protect the internal circuit 4 from the ESD current applied to the input terminal 3, the LSI is further provided with a PMOS 6 diode-connected between the power supply terminal 1 and the input terminal 3 and having a cathode connected to the power supply terminal 1 and an anode connected to the input terminal 3, and an NMOS 7 diode-connected between the ground terminal 2 and the input terminal 3 and having an anode connected to the ground terminal 2 and a cathode connected to the input terminal 3, in a manner similar to the LSI shown in FIG. 2. The output side of the internal circuit 4 is connected to the output terminal 5 via an inverter 8 constituted of a PMOS 8p and an NMOS 8n.

When the ESD current flows into the input terminal 3 in a grounded state of the ground terminal 2 in the LSI, the PMOS 6 is brought to an ON state to allow the ESD current to flow into the power supply terminal 1 side. Since the inflow of the surge current having flowed into the power supply terminal 1 side into the internal circuit 4 is blocked by the filter 10, the surge current raises the potential at the input terminal 3 while a rise in potential at the node NC is being suppressed. Thereafter, when the voltage at the input terminal 3 reaches a breakdown voltage of the NMOS 7, a parasitic bipolar transistor of the NMOS 7 is brought into conduction to allow the ESD current to flow into the ground terminal 2 side. With this operation, the internal circuit 4 can reliably be protected from the ESD current having flowed into the input terminal 3.

When an ESD current flows into the output terminal 5 in a state in which the ground terminal 2 is being grounded, the PMOS 8p is brought to an ON state to allow the ESD current to flow into the power supply terminal 1 side. Since the inflow of the surge current having flowed into the power supply terminal 1 side into the internal circuit 4 is blocked by the filter 10, the surge current raises the potential at the output terminal 5 while the rise in potential at the node NC is being suppressed. Thereafter, when the voltage at the output terminal 5 reaches a breakdown voltage of the NMOS 8n, a parasitic bipolar transistor of NMOS 8n is brought into conduction to allow the ESD current to flow into the ground terminal 2 side. With this operation, the internal circuit 4 can reliably be protected from the ESD current having flowed into the output terminal 5.

On the other hand, when an ESD current flows into the power supply terminal 1 in a state in which the ground terminal 2 is being grounded, the ESD current is blocked by the filter 10 to restrict the intrusion thereof into the internal circuit 4.

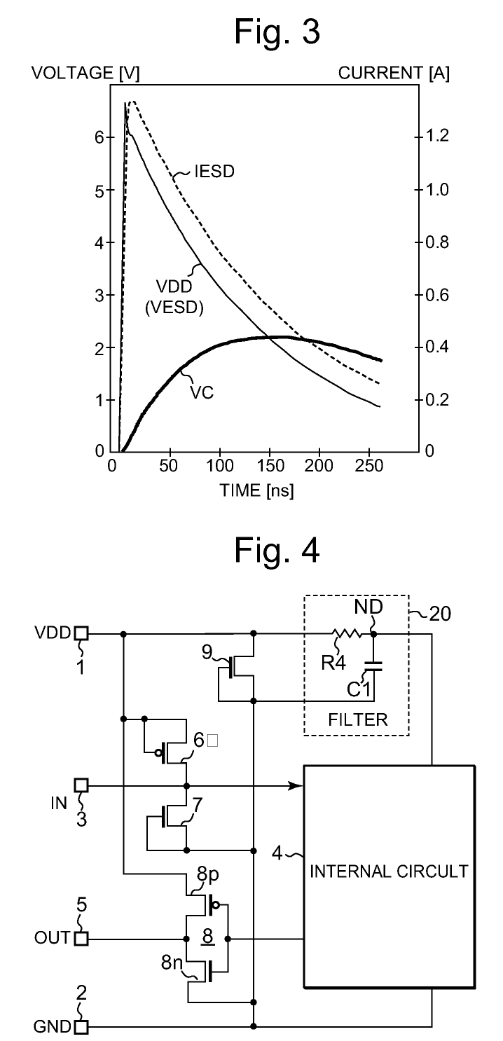

FIG. 3 is a signal waveform diagram showing the operation of FIG. 1. FIG. 1 shows changes in time with respect to an ESD current Iesd applied to the power supply terminal 1, a voltage Vesd generated at the power supply terminal 1 by the ESD current Iesd, and a voltage VC generated at the node NC.

When the ESD current Iesd is applied to the power supply terminal 1 as shown in FIG. 3, the voltage Vesd of the power supply terminal 1 rises with the ESD current Iesd. Since, however, the frequency band of 2 MHz is suppressed by the filter 10, a rise in the voltage VC supplied to the internal circuit 4 becomes slow. Thus, the NMOS 9 reaches a breakdown voltage prior to the corresponding transistor lying within the internal circuit 4, so that a parasitic bipolar transistor of the NMOS 9 is brought into conduction.

As described above, the LSI according to the first embodiment has the NMOS 9 diode-connected between the power supply terminal 1 and the ground terminal 2 and having the cathode connected to the power supply terminal 1 and the anode connected to the ground terminal 2, and the filter 10 for attenuating the specific frequency band (e.g., 2 MHz) for the voltage generated by the ESD current supplied to the power supply terminal 1. The LSI applies the power supply voltage VDD to the internal circuit 4 through the filter 10. It is therefore possible to attenuate the voltage produced by the ESD current having flowed into the power supply terminal 1 and suppress the voltage applied to the power supply terminal (node NC) of the internal circuit 4. Thus, the LSI has an advantage that since the NMOS 9 breaks down prior to the transistor in the internal circuit 4, the internal circuit 4 can reliably be protected from the ESD current.

### Second Preferred Embodiment

FIG. 4 is a configuration diagram showing an LSI equipped with an ESD protection circuit according to a second embodiment of the present invention. Constituent elements common to those in FIG. 1 are given common reference numerals respectively.

The present LSI is provided with a filter 20 different in configuration and function from the filter 10 as an alternative to the filter 10 shown in FIG. 1. The filter 20 is a low-pass filter based on an integration circuit constituted of a resistive element R4 connected between a power supply terminal 1 and a node ND corresponding to a power supply terminal of an internal circuit 4, and a capacitive element C4 connected between the node ND and a ground terminal 2. The more the time constant of the integration circuit increases, the more the advantageous effect is brought about. Since, however, a drop in power supply voltage becomes larger when the resistance value of the resistive element R4 is increased, whereas the required area of the integration circuit becomes larger when the capacitance value of the capacitive element C4 is increased, it is unrealistic. Accordingly, the time constant is set in such a manner that frequencies lying in a specific frequency band (e.g., 1 MHz) or more for a voltage generated by an ESD current can be attenuated. In the LSI, the voltage of the power supply terminal 1 rises with an ESD current Iesd when the ESD current Iesd is applied to the power supply terminal 1. While on the other hand, a rise in voltage VD at the node ND, which is supplied to the internal circuit 4, becomes slow since the frequency of 1 MHz or higher is suppressed by the filter 20. Thus, an NMOS 9 reaches a breakdown voltage prior to the corresponding transistor lying within the internal circuit 4, so that a parasitic bipolar transistor of the NMOS 9 is brought into conduction.

In the LSI, a PMOS 6 is brought to an ON state when an ESD current flows into an input terminal 3 in a grounded state of the ground terminal 2, thereby allowing the ESD current to flow into the power supply terminal 1 side. Since the inflow of the surge current having flowed into the power supply terminal 1 side into the internal circuit 4 is blocked by the filter 20, the surge current raises the potential at the input terminal 3 while the rise in potential at the node ND is being suppressed. Thereafter, when the voltage at the input terminal 3 reaches a breakdown voltage of an NMOS 7, a parasitic bipolar transistor of the NMOS 7 is brought into conduction to allow the ESD current to flow into the ground terminal 2 side. With this operation, the internal circuit 4 can reliably be protected from the ESD current having flowed into the input terminal 3.

When an ESD current flows into an output terminal 5 in a state in which the ground terminal 2 is being grounded, a PMOS 8p is brought to an ON state to allow the ESD current to flow into the power supply terminal 1 side. Since the inflow of the surge current having flowed into the power supply terminal 1 side into the internal circuit 4 is blocked by the filter 20, the surge current raises the potential at the output terminal 5 while the rise in potential at the node ND is being suppressed. Thereafter, when the voltage at the output terminal 5 reaches a breakdown voltage of an NMOS 8n, a parasitic bipolar transistor of the NMOS 8n is brought into conduction to allow the ESD current to flow into the ground terminal 2 side. With this operation, the internal circuit 4 can reliably be protected from the ESD current having flowed into the output terminal 5.

As described above, the LSI according to the second embodiment has the NMOS 9 diode-connected between the power supply terminal 1 and the ground terminal 2 and having a cathode connected to the power supply terminal 1 and an anode connected to the ground terminal 2, and the filter 20 for attenuating a high frequency component (e.g., 1 MHz or higher) of the voltage generated by the ESD current supplied to the power supply terminal 1. The LSI applies a power supply voltage to the internal circuit 4 through the filter 20. It is therefore possible to attenuate the voltage produced by the ESD current having flowed into the power supply terminal 1 and suppress the voltage applied to the internal circuit 4. Thus, the LSI has the advantage of being capable of simplifying a circuit configuration of the filter since the NMOS 9 breaks down prior to the transistor in the internal circuit 4, in addition to an advantage similar to the first embodiment.

Incidentally, the present invention is not limited to the above embodiments, and various modifications can be made. As the modifications, there are shown, for example, ones to be described below.

(1) While the resistive and capacitive elements are used as the filters 10 and 20 respectively, they may be configured using MOS transistors.

(2) The band-pass blocking filter and the low-pass filter can also be constituted using inductive elements such as a coil.

(3) A diode-connected PMOS, a diode, a bipolar transistor or a thyristor may be used as an alternative to the NMOS 9.

What is claimed is:

1. An electrostatic discharge protection circuit for protecting an internal circuit from an electrostatic discharge current applied to a power supply terminal of a semiconductor integrated circuit, comprising:
a protective element which is connected between the power supply terminal and a ground terminal and breaks down when a voltage of a constant value or larger is applied; and
a filter which is provided between the power supply terminal and the internal circuit and blocks passage of a frequency component of the electrostatic discharge current.

2. The electrostatic discharge protection circuit according to claim 1, where the filter is a band-pass blocking filter or a low-pass filter.

3. The electrostatic discharge protection circuit according to claim 2, wherein the filter comprises resistive and capacitive elements.

4. The electrostatic discharge protection circuit according to claim 2, wherein the filter comprises an inductive element and a capacitive element.

5. The electrostatic discharge protection circuit according to claim 3, wherein the resistive element is constituted of a MOS transistor.

6. The electrostatic discharge protection circuit according to claim 3, wherein the capacitive element is constituted of a MOS transistor.

7. The electrostatic discharge protection circuit according to claim 4, wherein the capacitive element is constituted of a MOS transistor.

8. The electrostatic discharge protection circuit according to any of claim 1, wherein the protective element is constituted of a MOS transistor, a bipolar transistor or a diode.
